(19) United States
(12) Patent Application Publication
(10) Pub. No.: US 2015/0331861 A1
(43) Pub. Date: Nov. 19, 2015

(54) METHOD AND MOBILE DEVICE OF AUTOMATICALLY SYNCHRONIZATING AND CLASSIFYING PHOTOS

(71) Applicant: AVerMedia TECHNOLOGIES, INC., NEW TAIPEI CITY (TW)

(72) Inventors: Shou-Kuo TAI, NEW TAIPEI CITY (TW); Chun-Tang HSU, NEW TAIPEI CITY (TW)

(21) Appl. No.: 14/446,327

(22) Filed: Jul. 29, 2014

(30) Foreign Application Priority Data
May 13, 2014 (TW) 103116855

(51) Int. Cl. G06F 17/30; G06K 9/00; G06K 9/62; H04L 12/58

(52) U.S. Cl. CPC G06F 17/30047; H04L 51/08; G06F 17/30578; G06F 17/30041; G06K 9/00288; G06K 9/6267

(57) ABSTRACT

A mobile device configured for automatically synchronizing and classifying photos. The mobile device includes a camera module, an identification module and a sharing module. The camera module is configured for generating at least one first photo. The identification module is configured for performing face identification on the at least one first photo according to a plurality of contact-person face photos, and for generating a face identification result. The sharing module is configured for automatically generating at least one sharing album, and for generating and transmitting a sharing message to a communication device of at least one of the contact persons who is identified being in the at least one first photo according to the face identification result such that the communication device receiving the sharing message automatically synchronizes at least one second photo to the at least one sharing album.

### RELATED APPLICATIONS

This application claims priority to Taiwanese Application Serial Number 103116855, filed May 13, 2014, which is herein incorporated by reference.

### BACKGROUND

1. Technical Field

The present disclosure relates to a method and a corresponding mobile device of automatically synchronizing and classifying photos. More particularly, the present disclosure relates to a method and a corresponding mobile device of automatically synchronizing and classifying photos by utilizing face identification techniques.

2. Description of Related Art

Current photo synchronization and classification methods on mobile devices usually need complicated steps when a group of users want to share photos with each other. For example, the users first have to create a group, manually classify and upload the photos, and manually download the photos of other friends in the group and so on.

Consequently, the users have to spend a lot of time to operate their mobile devices so as to share photos with their friends, especially for occasions that the users take many photos (e.g., traveling, gathering for dinner, and wedding).

### SUMMARY

In one aspect, the present disclosure is related to a mobile device configured for automatically synchronizing and classifying photos. The mobile device includes a camera module, an identification module and a sharing module. The camera module is configured for generating at least one first photo. The identification module is configured for performing face identification on the at least one first photo according to a plurality of contact-person face photos, and for generating a face identification result. The sharing module is configured for automatically generating at least one sharing album, and for generating and transmitting a sharing message to a communication device of at least one of the contact persons who is identified being in the at least one first photo according to the face identification result such that the communication device receiving the sharing message automatically synchronizes at least one second photo to the at least one sharing album.

In another aspect, the present disclosure is related to a method for automatically synchronizing and classifying photos. The method includes the following steps: generating at least one first photo; performing face identification on the at least one first photo according to a plurality of contact-person face photos, and generating a face identification result; automatically generating at least one sharing album; generating and transmitting a sharing message to a communication device of at least one of the contact persons who is identified being in the at least one first photo according to the face identification result; and the communication device receiving the sharing message automatically synchronizing at least one second photo to the at least one sharing album.

In the present disclosure, by utilizing face identification techniques on a photo, and automatically sharing photos to the persons identified being in the photo, the user does not need to select the persons he/she wants to share the photos with. Also, by automatically generating a sharing album and automatically synchronizing the photos taken by the user and sharing members to the sharing album, the user and the sharing members can share photos with each other quickly and instantly. Consequently, many steps and a lot of time required for sharing photos can be saved.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a mobile device configured for automatically synchronizing and classifying photos in accordance with one embodiment of the present disclosure;

FIG. 2 is a flow chart of a method for automatically synchronizing and classifying photos in accordance with one embodiment of the present disclosure;

FIG. 3 is a flow chart of a method for automatically synchronizing and classifying photos in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

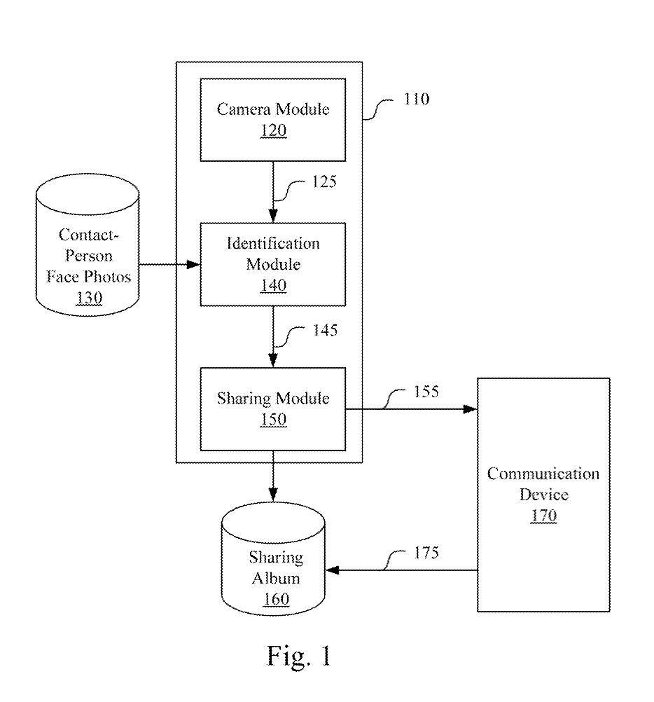

Reference is made first to FIG. 1. FIG. 1 is a schematic diagram of a mobile device 110 configured for automatically synchronizing and classifying photos in accordance with one embodiment of the present disclosure.

The mobile device 110 can be a smart phone, a tablet computer, smart glasses or a smart watch. The communication device 170 can also be a smart phone, a tablet computer, smart glasses or a smart watch. In an example, a user operates the mobile device 110, and one of his friends operates the communication device 170. The user wants to take photos of his friends by utilizing the mobile device 110 and shares the photos with his friends. The one of the user's friend operating the communication device 170 also shares photos with the user by utilizing the communication device 170.

The mobile device 110 includes a camera module 120, an identification module 140 and a sharing module 150.

The camera module 120 is configured for generating at least one first photo 125. In an example, the photo 125 includes a group consisting of more than one person.

In an embodiment of the present disclosure, the mobile device 110 includes memory and one or more processors. The identification module 140 and the sharing module 150 are stored in the memory and are configured for execution by the one or more processors.

The identification module 140 is configured for performing face identification on the first photo 125 according to a plurality of contact-person face photos 130, and for generating a face identification result 145.

In an embodiment of the present disclosure, the contact-person face photos 130 are parts of a contact list of a communication software (e.g., Line or Skype), of a social network software (e.g., Facebook or Google+), of an address book, or of a combination thereof. For example, the contact-person face photos 130 can be the profile photos of the user's friends on Facebook.

The sharing module 150 is configured for automatically generating at least one sharing album 160, and for generating and transmitting a sharing message 155 to a communication device 170 of at least one of the contact persons who is identified being in the first photo 125 according to the face identification result 145. The communication device 170 receiving the sharing message 155 automatically synchronizes at least one second photo 175 to the sharing album 160.

In an embodiment of the present disclosure, after the identification module 140 performs face identification on the first photo 125, the contact persons a, b, c and d are identified being in the first photo 125 according to the face identification result 145. The sharing module automatically generates the sharing album 160 (i.e., the user does not have to manually create/establish The sharing module automatically generates the sharing album 160), and adds the first photo 125 to the sharing album 160. Subsequently, the sharing module 150 generates and transmits the sharing message 155 to the communication devices 170 of the contact persons a, b, c and d (the communication devices 170 can be four or more than four smart phones, tablet computers, smart glasses or smart watches). Then the communication devices 170 of the contact persons a, b, c and d automatically synchronize a plurality of second photos 175 taken by the contact persons a, b, c and d to the sharing album 160 after receiving the sharing message 155.

In another embodiment of the present disclosure, the sharing album 160 is stored in a social network website (e.g., Facebook or Google+), in a photo website (e.g., Flickr), in a blog website, in a server, in the mobile device 110, or in the communication device(s) 170.

In one another embodiment of the present disclosure, the sharing message 155 includes an authentication request. The communication device 170 automatically synchronizes the second photo 175 to the sharing album 160 when the communication device 170 receives an input of a confirmation command responding to the abovementioned authentication request. The communication device 170 does not synchronize the second photo 175 to the sharing album 160 when the communication device 170 receives an input of a denial command responding to the abovementioned authentication request. In yet another embodiment of the present disclosure, the abovementioned authentication request is configured for asking if the user agrees to synchronize photos to the sharing album 160. When the user enters an input of a confirmation command responding to the abovementioned authentication request into the communication device 170, the communication device 170 automatically synchronizes the second photo 175 to the sharing album 160. When the user enters an input of a denial command responding to the abovementioned authentication request into the communication device 170, the communication device 170 does not synchronize the second photo 175 to the sharing album 160.

In still another embodiment of the present disclosure, the sharing message 155 includes a sharing period data, and the communication device 170 receiving the sharing message 155 is further configured for automatically synchronizing the second photo 175 taken during a time period corresponding to the abovementioned sharing period data to the sharing album 160. For example, the abovementioned sharing period data corresponds to a time period which is three days long. The communication device 170 receiving the sharing message 155 is configured for automatically synchronizing the second photo(s) 175 taken during the next three days to the sharing album 160.

In yet another embodiment of the present disclosure, the sharing message 155 includes a sharing region data, and the communication device 170 receiving the sharing message 155 is further configured for automatically synchronizing the second photo 175 taken within a geographic region corresponding to the sharing region data to the sharing album 160. For example, the abovementioned sharing region data corresponds to a geographic region which is 30 square-kilometers. The communication device 170 receiving the sharing message 155 detects the location of its user by utilizing a built-in GPS module, and automatically synchronizes the second photo(s) 175 taken within the geographic region of 30 square-kilometers centered at its user's current location to the sharing album 160.

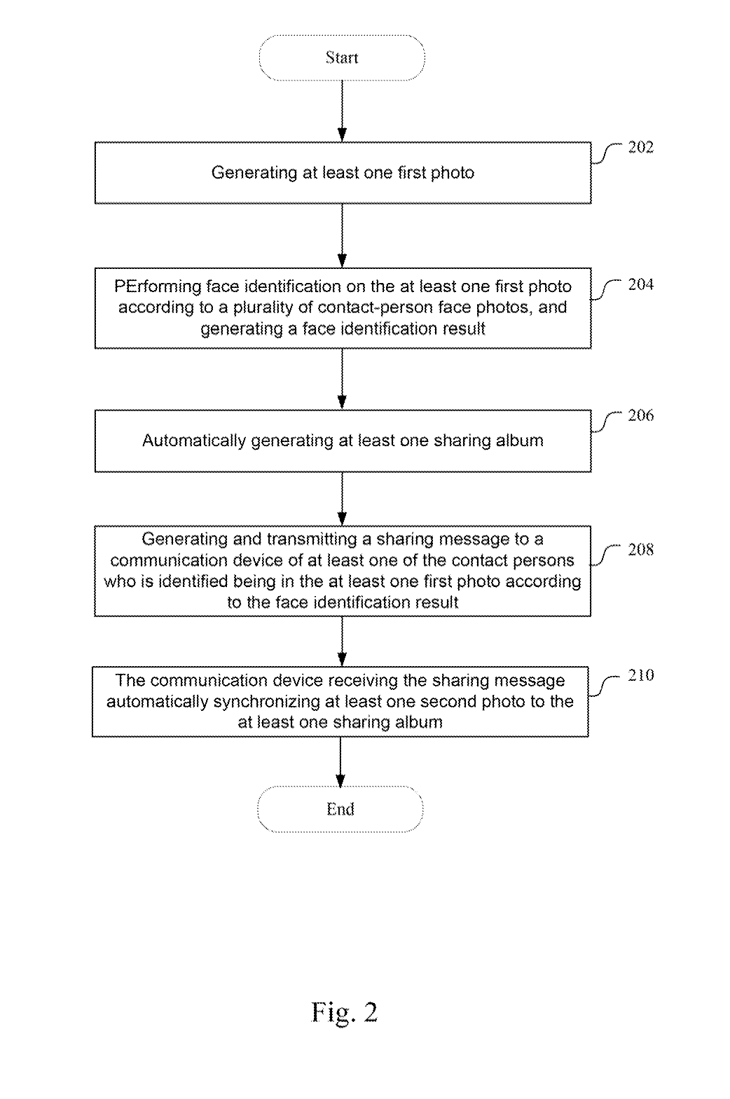

Reference is made also to FIG. 2. FIG. 2 is a flow chart of a method for automatically synchronizing and classifying photos in accordance with one embodiment of the present disclosure. The method for automatically synchronizing and classifying photos may take the form of a computer program product stored on a computer-readable storage medium having computer-readable instructions embodied in the medium. Any suitable storage medium (such as non-transitory medium) may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. The method for automatically synchronizing and classifying photos may be applied in the mobile device 110 illustrated in FIG. 1, but is not limited in this regard. For convenience and clarity, it is assumed that the method for automatically synchronizing and classifying photos is applied in the mobile device 110 illustrated in FIG. 1.

In step 202, the camera module 120 generates at least one first photo 125.

In step 204, the identification module 140 performs face identification on the first photo 125 according to a plurality of contact-person face photos 130, and generating a face identification result 145.

In step 206, the sharing module 150 automatically generates at least one sharing album 160.

In step 208, the sharing module 150 generates and transmits a sharing message 155 to a communication device 170 of at least one of the contact persons who is identified being in the first photo 125 according to the face identification result 145.

In step 210, the communication device 170 receiving the sharing message 155 automatically synchronizes at least one second photo 175 to the sharing album 160.

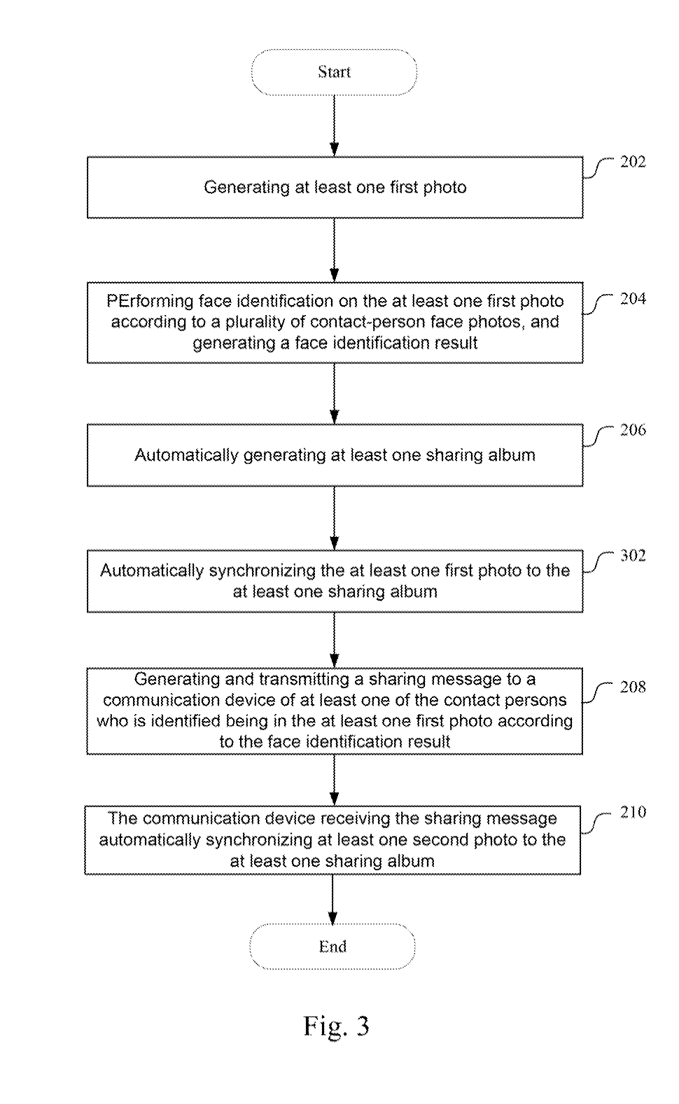

Additional reference is made to FIG. 3. FIG. 3 is a flow chart of a method for automatically synchronizing and classifying photos in accordance with one embodiment of the present disclosure. The method for automatically synchronizing and classifying photos may be applied in the mobile device 110 illustrated in FIG. 1, but is not limited in this regard. For convenience and clarity, it is assumed that the method for automatically synchronizing and classifying photos is applied in the mobile device 110 illustrated in FIG. 1.

Compared with the method for automatically synchronizing and classifying photos illustrated in FIG. 2, the method for automatically synchronizing and classifying photos illustrated in FIG. 3 further includes step 302.

In step 302, the sharing module 150 automatically synchronizes the first photo 125 to the sharing album 160.

The above illustrations include exemplary operations, but the operations are not necessarily performed in the order shown. Operations may be added, replaced, changed order, and/or eliminated as appropriate, in accordance with the spirit and scope of various embodiments of the present disclosure.

In the present disclosure, by utilizing face identification techniques on a photo, and automatically sharing photos to the persons identified being in the photo, the user does not need to select the persons he/she wants to share the photos with. Also, by automatically generating a sharing album and automatically synchronizing the photos taken by the user and sharing members to the sharing album, the user and the sharing members can share photos with each other quickly and instantly. Consequently, many steps and a lot of time required for sharing photos can be saved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A mobile device for automatically synchronizing and classifying photos, the mobile device comprising:
a camera module configured for generating at least one first photo;
an identification module configured for performing face identification on the at least one first photo according to a plurality of contact-person face photos, and for generating a face identification result; and
a sharing module configured for automatically generating at least one sharing album, and for generating and transmitting a sharing message to a communication device of at least one of the contact persons who is identified being in the at least one first photo according to the face identification result such that the communication device receiving the sharing message automatically synchronizes at least one second photo to the at least one sharing album.

2. The mobile device of claim 1, wherein the sharing message comprises an authentication request and the communication device automatically synchronizes the at least one second photo to the at least one sharing album when the communication device receives an input of a confirmation command responding to the authentication request; and the communication device does not synchronize the at least one second photo to the at least one sharing album when the communication device receives an input of a denial command responding to the authentication request.

3. The mobile device of claim 1, wherein the sharing message comprises a sharing period data, and the communication device receiving the sharing message is further configured for automatically synchronizing the at least one second photo taken during a time period corresponding to the sharing period data to the at least one sharing album.

4. The mobile device of claim 1, wherein the sharing message comprises a sharing region data, and the communication device receiving the sharing message is further configured for automatically synchronizing the at least one second photo taken within a geographic region corresponding to the sharing region data to the at least one sharing album.

5. The mobile device of claim 1, wherein the plurality of contact-person face photos are parts of a contact list of a communication software, of a social network software, of an address book, or of a combination thereof.

6. The mobile device of claim 1, wherein the sharing module is further configured for automatically synchronizing the at least one first photo to the at least one sharing album.

7. A method for automatically synchronizing and classifying photos, the method comprising:
generating at least one first photo;
performing face identification on the at least one first photo according to a plurality of contact-person face photos, and generating a face identification result;
automatically generating at least one sharing album;
generating and transmitting a sharing message to a communication device of at least one of the contact persons who is identified being in the at least one first photo according to the face identification result; and
the communication device receiving the sharing message automatically synchronizing at least one second photo to the at least one sharing album.

8. The method of claim 7, wherein the sharing message comprises an authentication request and the communication device automatically synchronizes the at least one second photo to the at least one sharing album when the communication device receives an input of a confirmation command responding to the authentication request; and the communication device does not synchronize the at least one second photo to the at least one sharing album when the communication device receives an input of a denial command responding to the authentication request.

9. The method of claim 7, wherein the sharing message comprises a sharing period data, and the communication device receiving the sharing message is further configured for automatically synchronizing the at least one second photo taken during a time period corresponding to the sharing period data to the at least one sharing album.

10. The method of claim 7, wherein the sharing message comprises a sharing region data, and the communication device receiving the sharing message is further configured for automatically synchronizing the at least one second photo taken within a geographic region corresponding to the sharing region data to the at least one sharing album.

11. The method of claim 7, wherein the plurality of contact-person face photos are parts of a contact list of a communication software, of a social network software, of an address book, or of a combination thereof.

12. The method of claim 7 further comprising:
automatically synchronizing the at least one first photo to the at least one sharing album.
